(19) United States
(12) Patent Application Publication
(10) Pub. No.: US 2007/0239799 A1
(43) Pub. Date: Oct. 11, 2007

(54) Analyzing log files

(76) Inventor: Anirudh Modi, Portland, OR (US)

Correspondence Address: TROP PRUNER & HU, PC, 1616 S. VOSS ROAD, SUITE 750, HOUSTON, TX, 77057-2631, US

(21) Appl. No.: 11/392,858

(22) Filed: Mar. 29, 2006

(51) Int. Cl. G06F 17/30

(52) U.S. Cl. 707/202

(57) ABSTRACT

Log files from disparate systems may be transformed to a common format. That common format may then be searched for information resident in log files from both systems. In some embodiments, this enables disparate log files to be quickly searched, particularly where specific types of log files may be identified for searching.

### BACKGROUND

This relates generally to parsing and searching log files.

A variety of computer systems and applications generate log files. A log file is any file that lists actions that have occurred. For example, Web server log files list every request made to the server.

In complex systems, a variety of different elements may each have their own log files. For example, in a semiconductor fabrication facility, log files may be generated by individual tools within that facility, by middleware that helps to manage the tools and by back end systems that do transaction processing. Each of these elements may be developed by different entities for different purposes and their log files may be incompatible.

It is known to search the log files of any given system. Log file information is particularly useful in debugging and performance analysis, particularly when the system is being developed.

Because of the number of individual files that make up the log file in any given element or system, the number of log files quickly becomes enormous in multi-element systems, such as server farms and semiconductor fabrication facilities. Finding particular information within log files may become difficult. This difficulty is enhanced in the case where a given system may have a variety of elements, each of which keeps its own log files in disparate formats.

### BRIEF DESCRIPTION OF THE DRAWINGS

FIG. 1 is a schematic depiction from an application perspective in accordance with one embodiment of the present invention;

FIG. 2 is a schematic depiction from a source perspective in accordance with another embodiment of the present invention;

FIG. 3 is a flow chart for one embodiment of the present invention; and

FIG. 4 is a system depiction for one embodiment.

### DETAILED DESCRIPTION

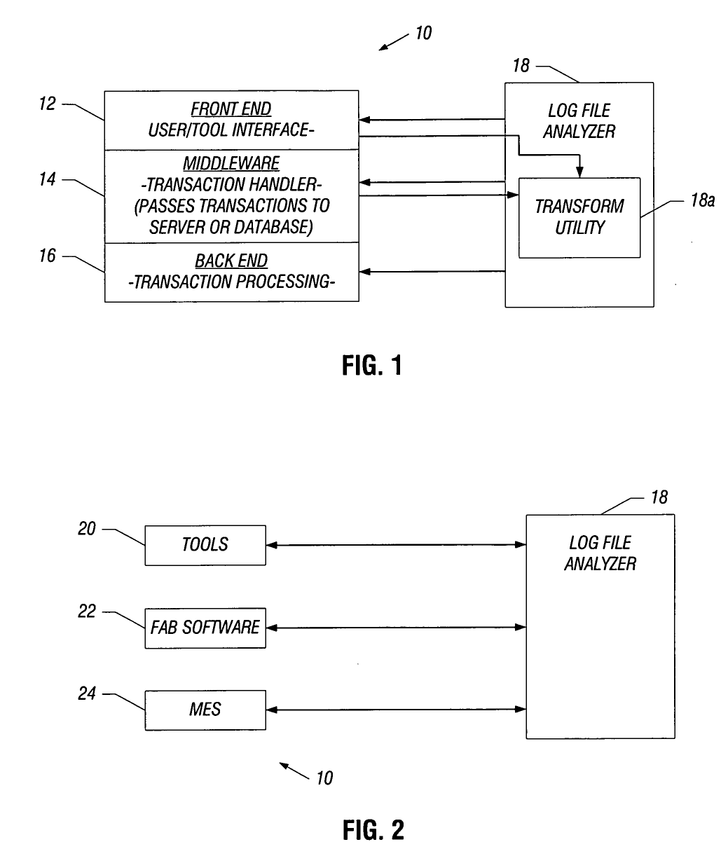

Referring to FIG. 1, a log file analyzer 18, in accordance with some embodiments of the present invention, may be capable of analyzing, searching, and locating specific log files within disparate systems that maintain their own separate log files. These disparate systems may include a large number of elements, each of which maintain their own log files. However, those log files may be related in a functional sense in that some of the log file information may be common even where the log files are kept in different formats.

For example, in connection with a semiconductor manufacturing facility, disparate log files may be provided by disparate systems. Front end applications may generate log file information in a first format. The front end systems may include user/tool interfaces. These systems may be prepared by tool manufacturers or by the semiconductor facility owner. These applications may, in turn, communicate with middleware applications 14. The middleware is basically transaction handlers which pass transactions initiated from the user/tool interface of the front end 12 to a server or database. The server or database may be associated with back end applications 16 which do the transaction processing. The back end systems may be manufactured by one entity and may generate log files in a different format than the middleware or the front end. Similarly, the middleware 14 may be developed by a different entity and may generate log files in a format different from that used by the front end 12 or the back end 16.

The log file analyzer 18 may include a transform utility 18a which transforms the formats of the various disparate systems into a uniform grid which may be searched. For example, all log files may have certain common features. Generally, log files will have a field with a date, a time, a transaction name, and a user identifier, as well as a transaction identifier. The exact format of the log files may vary, but common information is generally available in most log files generated by commercial software.

Thus, the transform utility 18a may have plug-ins for each disparate element or system in one embodiment. These plug-ins may be able to determine where those pieces of known log file information reside within disparate applications written by different entities. They may extract this common information to enable log file analysis by the log file analyzer 18, regardless of the original log file format. Specifically, the transform utility 18a may find and extract information, like date and time of the transaction, metrics, such as the time the transaction took, user identifiers, indicating which user initiated the transaction, mode, such as a machine name, and identifiers of the specific transaction.

With this information, a given transaction on one element or system can be tracked across all the disparate systems. For example, a transaction that occurred at the front end 12 may be tracked by its log file identifier through the middleware 14 and the back end 16. Alternatively, related transactions may be traced through the disparate systems or elements using time information. For example, it may be known when a transaction occurred on the front end and, based on that information, it can be determined approximately when the transaction occurred, in the middleware or the back end. Thus, the time information may be used to locate related log file information from different log file generating elements.

Using a suitably defined time window, the middleware and the back end may be searched for related transactions. In this way, it is possible to determine how different transactions progress through the various log files of different applications.

More particularly, once a given log file transaction or error is located, users may effectively turn back time to analyze precisely what happened across a variety of different levels and applications within disparate systems.

As a specific example, suppose that a back end system fails. The question may arise as to how many tools will be impacted within a semiconductor fabrication facility. There may be 700 tools in the fabrication facility. To go through all the log files for all 700 tools would take an enormous amount of time. By the time an answer is obtained, it may be too late to plan for or mitigate the resulting damage.

With some embodiments of the present invention, a back end failure can be isolated in terms of a transaction identifier or a specific time when it occurred. Effects on other systems, even though they may have disparate log file formats, can be identified by localized and specific searching within specific time windows. Thus, in some cases, specific fields may be searched, such as user or transaction identifiers or time fields, so that information can be quickly obtained using the transform utility 18a.

As another more specific example, a user interface may receive a “get lot status” call, which amounts to a transaction in a semiconductor fabrication facility. That transaction has a name and a number or identifier. That unique identifier goes to the middleware layer which logs the transaction by its name and identifier, although it may generate a log file in a format different from the format of the front end 12 log files. Then, the transaction may go to the back end that logs the transaction using that same name and identifier, but still uses a different log file format. The back end then makes the call to actually do the transaction. The user may note that the transaction took 30 seconds and may want to know what took all that time. By using a time window or a transaction name or identifier window, a focused search may be made through log files of disparate systems in disparate formats to determine an answer to the user's question.

Referring to FIG. 2, the system 10 of FIG. 1 may be broken down differently. In this case, the log file analyzer 18 analyzes log files related to disparate log file generating elements. Those elements may be the tools 20, the fabrication facility software 22, and the manufacturing execution system (MES) software 24. That software may be further broken down into front end, middleware, and back end applications, but they may be more recognizable in the format shown in FIG. 2.

For example, in the case of a semiconductor fabrication facility, hundreds of tools may constitute separate processor-based systems, each running software which develops separate log files. Similarly, the fabrication facility software 22 may be operating to develop its own separate log files. Finally, the manufacturing execution system (MES) may be generating its own log files. The log file analyzer 18 receives selected portions of all those log files and is capable of transforming them into a common searchable format. This enables quicker results, as well as the ability to track errors and log file information across disparate systems.

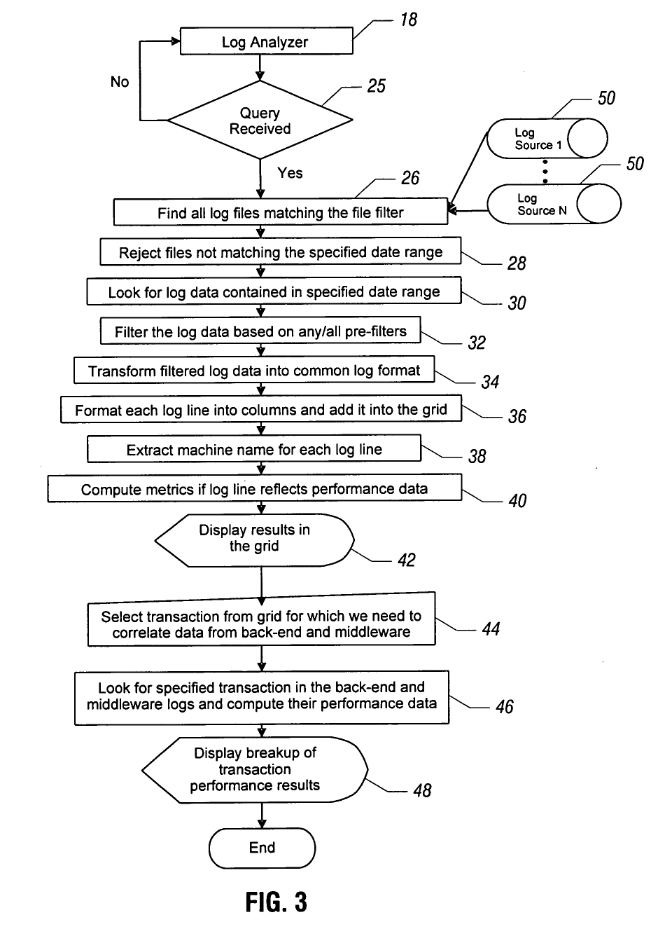

Referring to FIG. 3, the log file analyzer 18 may be implemented in software, hardware, or firmware. The log file analyzer 18 may be a separate application, in some embodiments of the present invention, which may run, for example, in association with back end 16 or any other layer, level, or system. Initially, the log file analyzer 18 determines whether it has received a query as determined in diamond 25. If so, it attempts to locate log files related to the information the user wants.

It may do this by displaying a query user interface. That user interface may, for example, ask the user to provide information to guide or limit the search to a workable body of log files. A user interface may include a field for the insertion of date and time of the query. In other words, the user may be asked to specify a date or a date and time window for localizing the search and making the search more efficient. After displaying the user interface, the analyzer 18 may receive the date or time data input.

Then, the analyzer 18 finds all log files that have the user specified characteristic as indicated in block 26. The search may search through some number n of log file sources 50 associated, for example, with tools, front or back end applications, or middleware using information, such as the specific nature of the transaction, which the user wishes to search. Specific fields within the log files may be searched, such as time, date, metrics, or the like. Files not matching a specified date range may be rejected as indicated in block 28.

A machine names user interface may be displayed. The machine names interface may provide a listing of all the various machines such as the semiconductor fabrication tools which are available through the log analyzer 18 for log file analysis. The user can then select or click on the specific machines of interest. Only those machines may be searched through their log files to identify responsive information. Thus, the analyzer 18 receives any machine name input.

Next, the analyzer 18 queries the user for identifier information. The identifier information may be provided directly from the user or the identifier may be extracted from the information already provided. In other words, the log file analyzer 18 may itself determine the identifier for specific types of transactions that may already be identified by the user. Then, the requested information is parsed from the requested fields in the front end, middleware, and back end application log files.

Thus, the analyzer 18 looks for log file data contained within a specified date range as indicated in block 30. That is, within the files located as matching the file filter, the second filtering may be done based on the specified date range or window.

Then, the log file data may be filtered based on any or all assigned pre-filters as indicated in block 32. The idea is to limit the amount of log file information that must be searched and transformed into a common log file format, making the search quicker and more efficient. The filtered log data is then transformed into a common log format using the transform utility 18a, as indicated in block 34. More specifically, each log line may be formatted into columns and added into the end of a grid that is built by the log analyzer 18 as indicated in block 36. A machine name may be extracted for each log line as indicated in block 38. Metrics may be computed if the log line reflects performance data as indicated in block 40.

Then, the results may be displayed in a grid as indicated in block 42. A transaction may be selected from the grid for which data needs to be correlated from back end and middleware applications as indicated in block 44. The specified transaction may be found in the back end and middleware log files and their performance data may be computed as indicated in block 46. The transaction breakup and performance results may be displayed. For example, the results may be displayed for specific applications, such as front end, middleware, or back end, or for specific sources such as specific tools and specific applications as indicated in block 48.

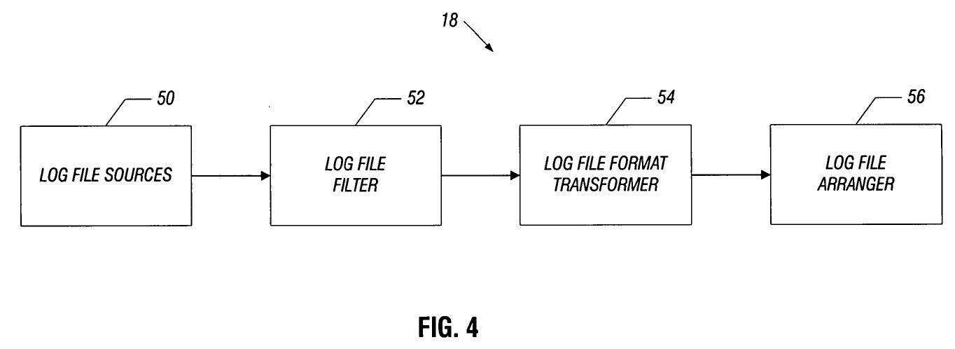

Referring next to FIG. 4, the log file analyzer 18 may be made up of modules which perform specific tasks. The modules include the log file filter 52 that searches the log file sources 50 to apply filter criteria to select the desired log file information. This avoids the need to transform the format of every single log file before doing any searching. In other words, the universe of log files that are transformed in format is first reduced, before doing the file format transformation.

Then, the log file format transformer 54 takes the log files from disparate sources in different formats and transforms them into a more basic, but uniform, arrangement so that specific information is in specific fields recognized by the log file analyzer 18.

The output from the log file format transformer 54 is passed to a log file arranger 56. The log file arranger 56 organizes the selected log file information, which has now been located, in a desired format. For example, the log file information may be broken down in ways that make the information more user friendly. As examples, the information may be broken down into information from specific entities such as front end, back end, or middleware or specific tools or types of tools in a semiconductor application or specific applications within a given class which have their own log files and may be of particular interest.

While numerous examples are given herein of the log file analyzer useful in semiconductor applications, embodiments of the present invention have many other applications. Among those applications include analyzing log files of diverse servers in a server farm and analyzing log files from various Web servers. Many more applications will occur to those skilled in the art.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
transforming log files from at least two disparate systems to a common format; and
searching both log files in said common format.

2. The method of claim 1 including reducing the number of log files to be transformed to a common format before transforming the log files to the common format.

3. The method of claim 2 including applying a filter to reduce the number of log files before transforming said log files to the common format.

4. The method of claim 3 including applying a filter to filter out log files falling outside a given time range.

5. The method of claim 1 including analyzing log files from a semiconductor fabrication facility.

6. The method of claim 5 including analyzing log files from semiconductor fabrication tools.

7. The method of claim 6 including analyzing log files from a manufacturing execution system.

8. The method of claim 6 including analyzing log files from front end, middleware, and back end elements.

9. The method of claim 1 including organizing log file information based on log file information sources.

10. The method of claim 9 including extracting a machine name from a log file.

11. A machine readable medium storing instructions to enable a processor-based system to:
transform log files from at least two disparate systems to a common format; and
search both log files in said common format.

12. The medium of claim 11 further storing instructions to reduce the number of log files to be transformed to a common format before transforming log files to the common format.

13. The medium of claim 12 further storing instructions to apply a filter to reduce the number of log files before transforming said log files to the common format.

14. The medium of claim 13 further storing instructions to apply a filter to filter out log files falling outside a given time range.

15. The medium of claim 11 further storing instructions to analyze log files from a semiconductor fabrication facility.

16. The medium of claim 15 further storing instructions to analyze log files from semiconductor fabrication tools.

17. The medium of claim 16 further storing instructions to analyze log files from a manufacturing execution system.

18. The medium of claim 16 further storing instructions to analyze log files from front end, middleware, and back end elements.

19. The medium of claim 11 further storing instructions to organize log file information based on log file information sources.

20. The medium of claim 19 further storing instructions to extract the machine name from a log file.

21. A system comprising:
a log file filter to filter log files of interest from at least two different systems that maintain separate log files;
a log file format transformer coupled to said filter to transform the format of the log files to a common format; and
a log file arranger to arrange the files for display.

22. The system of claim 21 wherein said system is a semiconductor fabrication system.

23. The system of claim 22 wherein said system to obtain log files from semiconductor tools.

24. The system of claim 23 wherein said system to obtain log files from a manufacturing execution system.

25. The system of claim 21 wherein said log file filter to filter log files for selection based on a time window.

26. The system of claim 21 wherein said filter to filter based on a log file transaction identifier.

27. The system of claim 21 wherein said transformer locates certain common pieces of information in different log files and organizes them into a common format.

28. The system of claim 21 wherein said arranger to arrange log file information for display based on the source of the log file.

29. The system of claim 21 to extract log file information from front end, middleware, and back end elements.
